(19) United States
(12) Patent Application Publication
(10) Pub. No.: US 2009/0082015 A1
(43) Pub. Date: Mar. 26, 2009

(54) SYSTEMS AND METHODS FOR CONTROLLING MOBILE UNIT ACCESS TO NETWORK SERVICES BASED ON ITS LOCATION

(75) Inventors: Ranjith RAVI, San Jose, CA (US); Saurabh BHARGAVA, San Jose, CA (US); Shilpa MOGHE, San Jose, CA (US); Ajay MALIK, Santa Clara, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 11/861,507

(22) Filed: Sep. 26, 2007

(51) Int. Cl. H04Q 7/20

(52) U.S. Cl. 455/433

(57) ABSTRACT

Methods and systems for controlling mobile unit access to network services based on the location of the mobile unit are disclosed. One system includes determining if the mobile unit is located within an area and enabling access to the network services, by the mobile unit, in response to determining that the mobile unit is located within the area. A system includes a reader configured to determine if a mobile unit is located within the area and a switch coupled to the reader. The switch is configured to provide access to the network services, to the mobile unit, in response to the reader determining that the mobile unit is located within the area. An apparatus includes means for determining if a mobile unit is located within the area and means for enabling the mobile unit to access the network services in response thereto.

### FIELD OF THE INVENTION

The present invention relates generally to radio frequency identification (RFID) systems, wireless local area networks (WLANs), and other such networks incorporating RF tags, and, more particularly, to systems and methods for controlling mobile unit access to network services based on the location of the mobile unit.

### BACKGROUND OF THE INVENTION

In recent years, radio frequency identification (RFID) systems have achieved wide popularity in a number of applications, as they provide a cost-effective way to track the location of a large number of assets in real time. In large-scale applications (e.g., warehouses, retail spaces, and the like), many types of tags may exist in the area (or “site”). Likewise, multiple types of RFID readers, such as active tag readers, 802.11 tag readers, Zigbee tag readers, and the like are typically distributed throughout the space in the form of entryway readers, conveyer-belt readers, mobile units, etc., and may be linked by network controller switches and the like.

For security reasons, it may be desirable to know the location of a mobile unit (e.g., a laptop computer, cellular telephone, PDA, Blackberry®, etc.) within a building or other such site. In addition, it may also be desirable to limit the mobile unit's access to a network to a specific geographic location to prevent unauthorized entities or persons from accessing the network.

Accordingly, it is desirable to provide systems and methods for controlling mobile unit access to network services based on the location of the mobile unit. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

Methods are provided for controlling mobile unit access to network services based on the location of the mobile unit. One exemplary method comprises the steps of determining if the mobile unit is located within an area and enabling access to the network services, by the mobile unit, in response to determining that the mobile unit is located within the area.

Systems for controlling mobile unit access to network services based on its location are also provided. An exemplary system comprises a reader configured to determine if the mobile unit is located within an area. The system also comprises a switch coupled to the reader, wherein the switch is configured to provide access to the network services, to the mobile unit, in response to the reader determining that the mobile unit is located within the area.

Apparatus are also provided for controlling mobile unit access to network services based on the location of the mobile unit. One exemplary apparatus comprises means for determining if the mobile unit is located within an area and means for enabling the mobile unit to access the network services in response to determining that the mobile unit is located within the area.

### BRIEF DESCRIPTION OF THE DRAWINGS

The present invention will hereinafter be described in conjunction with the following drawing figure, wherein

FIG. 1 is schematic diagram of one exemplary embodiment of a system for controlling mobile unit access to network services based on the location of the mobile unit.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission and data formatting protocols and that the system described herein is merely one example embodiment of the invention.

For the sake of brevity, conventional techniques related to signal processing, data transmission, signaling, network control, the 802.11 family of specifications, wireless networks, RFID systems and specifications, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

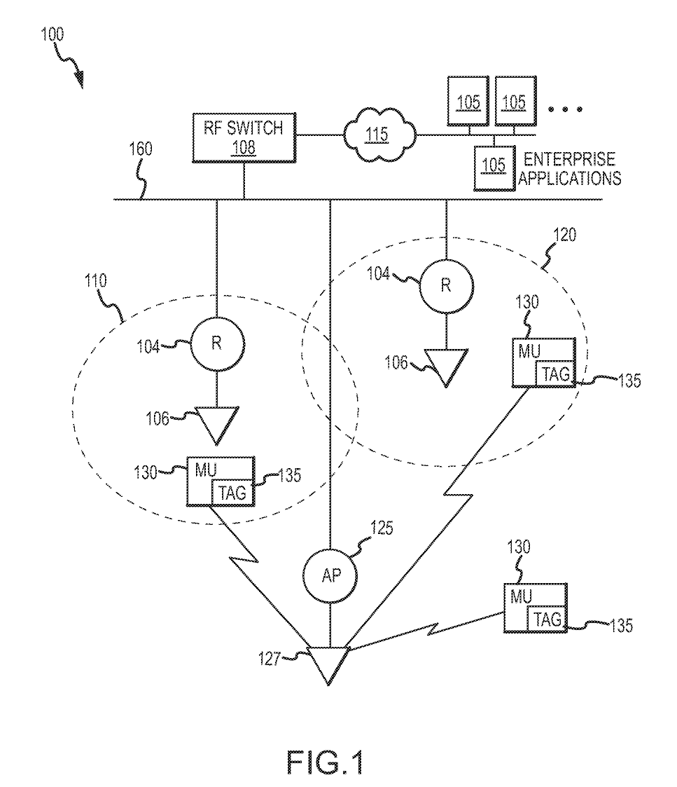

FIG. 1 is schematic diagram of one exemplary embodiment of a system 100 for controlling mobile unit access to network services based on the location of the mobile unit 130 (“MU”). As illustrated, system 100 includes one or more RFID readers 104, an RF switch 108, a network 115 (wireless local area network (WLAN)), and one or more enterprise applications 105 (e.g., the Internet, email, instant/text messaging, etc.) coupled to one another. Specifically, RFID reader 104, which may be stationary or mobile, is suitably connective to RF switch 108 via wired or wireless data links and is in communication with one or more wireless access ports 125 (alternatively referred to as “access ports” or “APs”) that are configured to wirelessly connect to one or more MUs 130.

Each RFID reader 104 includes one or more associated antennas 106, and may incorporate additional functionality, such as filtering, cyclic-redundancy checks (CRC), and tag writing, as is known in the art. Each antenna 106 associated with RFID reader 104 has an associated RF range defining an area (e.g., areas 110 and 120). The size and dimensions, among other things, of areas 110 and 120 depend on the respective power of antennas 106. Specifically, areas 110 and 120 correspond to the area around antennas 106 in which an RFID tag 135 may be detected by antennas 106, and may be defined by a variety of shapes and sizes, depending on the nature of antennas 106. Notably, it is common for RF ranges or read points of two or more antennas 106 to overlap in real-world applications (e.g., doorways, small rooms, etc.), as shown by the overlap in areas 110 and 120.

Areas 110 and 120 may correspond to physical spaces within a workplace, a retail store, a home, a warehouse, or any other such site, and will typically include various physical features that affect the nature and/or strength of RF signals received and/or sent by RFID reader 104. Such features include, for example, architectural structures such as doors, windows, partitions, walls, ceilings, floors, machinery, lighting fixtures, and the like. Note that the present invention is not limited to two-dimensional layouts, and may be implemented within three-dimensional spaces as well.

Each RFID reader 104 is configured to detect the presence of any MUs 130 within its respective area (i.e., areas 110 and 120) and provide the identifier of any detected MU(s) 130 (obtained via RFID tag 135) to RF switch 108. In accordance with one exemplary embodiment, each RFID reader 104 is also configured to monitor the MUs 130 within its respective area, notify RF switch 108 when an MU 130 leaves its area, and also notify RF switch 108 when the MU 130 returns to its area.

RF switch 108 includes hardware, software, and/or firmware capable of carrying out the functions described herein. Thus, RF switch 108 may comprise one or more processors accompanied by memory, displays, input/output devices, an operating system, database management software, networking software, and the like. Such systems are well known in the art, and need not be described in detail. RF switch 108 may be configured as a general purpose computer, a network switch, or any other such network host. In a preferred embodiment, controller or RF switch 108 is modeled on a network switch architecture but includes RF network controller software (or “module”) whose capabilities include, among other things, the ability to selectively transmit packets to MUs 130.

RF switch 108 is configured to transmit and receive various signals from MUs 130. RF switch 108 is able to support any number of MUs 130 that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

In one exemplary embodiment, RF switch 108 is configured to receive the identifier(s) of any MU(s) 130 within area 110 and/or 120 from RFID readers 104, and provides the MU(s) 130 with access to various services provided by network 115 in response thereto. RF switch 108 is also configured to receive the identifier(s) of any MU(s) 130 that are no longer within area 110 and/or 120 from RFID readers 104, and prevent the MU(s) 130 from accessing or terminate access to the various services provided by network 115 in response thereto.

Specifically, RF switch 108 is configured to create and maintain (update) a routing list identifying the MUs 130 within areas 110 and/or 120. The routing list may be generated using, for example, a suitable packet handling process, as is known in the art. When a packet is to be routed to an MU 130, RF switch 108 checks the routing list to determine if the MU 130 is listed on the routing list (i.e., is located within area 110 and/or 120). If an MU 130 is located within area 110 and/or 120, as indicated by the routing list, RF switch 108 is configured to determine the destination of packets it receives over network 115 and route these packets to AP 125 for transmittal to the appropriate MU 130. If an MU 130 is not located within area 110 and/or 120 (i.e., is not on the routing list or has been removed from the routing list either because the MU 130 has never entered area 110 and/or 120 or has left area 110 and/or 120), RF switch 108 is configured to not transmit the packets received over network 115 to AP 125, which in turn prevents the MU 130 from receiving the packets.

AP 125 may be any suitable access port and may have a number of associated MUs 130. Specifically, AP 125 is configured to suitably communicate with RF switch 108 via appropriate communication lines 160 (e.g., conventional Ethernet lines, or the like). Thus, AP 125 acts primarily as a conduit, sending/receiving RF transmissions via MUs 130, and sending/receiving packets via a network protocol with RF switch 108.

For wireless data transport, AP 125 may support one or more wireless data communication protocols—e.g., RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; GPRS; and proprietary wireless data communication protocols such as variants of Wireless USB.

MUs 130 may be any device capable of wirelessly communicating with AP 125. Examples of MUs 130 include, but are not limited to laptop computers, cellular telephones, PDAs, Blackberry® devices, and the like mobile devices. Each MU 130 includes an RFID tag 135 (“RF tag,” or simply “tag”) capable of being read by RFID readers 104 when MU 130 is within areas 110 or 120. As used herein, the term “RFID” is not meant to limit the invention to any particular type of tag. The term “tag” refers, in general, to any RF element that can be communicated with and has an ID (or “ID signal”) capable of being read by another component.

The following example may be beneficial in understanding the operation of system 100; however, the invention is not limited to this example. Initially, each RFID reader 104 monitors its respective area (i.e., area 110 or 120) to determine (via reading an associated RFID tag 135) if an MU 130 is within its respective area. If an RFID reader 104 determines that an MU 130 is within its area, RFID reader 104 reads the identifier of the MU 130 and transmits a signal providing the identifier to RF switch 108. RF switch 108 then adds the identifier to the routing list and routes any packets received from network 115 to the MU 130 (via AP 125) until the MU 130 is removed from the routing list (i.e., leaves area 110 and/or 120).

Each RFID reader 104 continues to monitor areas 110 and 120 to determine if the MU 130 remains within area 110 and/or 120. If the RFID reader 104 determines that an MU 130 is no longer within its area, the RFID reader 104 transmits a signal to RF switch 108 indicating such. RF switch 108 then removes the MU 130 from the routing list and will not transmit packets from network 115 to the MU 130 unless the MU 130 is returned to area 110 and/or 120 (i.e., is once again added to the routing list).

If the MU 130 is returned to area 110 and/or 120, the appropriate RFID reader 104 notifies RF switch 108 of such. RF switch 108 then updates the routing list (i.e., adds the MU 130 to the routing list) and once again transmits packets from network 115 to that particular MU 130. Notably, although the above example describes system 100 as having one MU 130, system 100 is capable of enabling access to network 115 to a plurality of MUs 130 when they are located within area 110 and/or 120. Moreover, RF switch 108 will not transmit packets to AP 125 for transmittal to MUs 130 located outside areas 110 and 120. That is, packets from network 115 will not be transmitted to any MUs 130 that are not on the routing list.

While an 802.11-type area is described above, the methods described apply to any system or protocol that uses RSSI as a driving decision for computation, for example, RFID, WiMax, WAN, Bluetooth, Zigbee, UWB, and the like. Furthermore, the methods described above may be performed in hardware, software, or a computer module incorporating a combination thereof. This computer module may be included within RFID reader 104, RF switch 108, AP 125, or MU 130.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A method for controlling mobile unit access to network services based on a location of a mobile unit, the method comprising the steps of:
determining if the mobile unit is located within an area; and
enabling access to the network services, by the mobile unit, in response to determining that the mobile unit is located within the area.

2. The method of claim 1, further comprising the step of determining if the mobile unit remains located within the area.

3. The method of claim 2, further comprising the step of continuing to enable the mobile unit to access the network services while the mobile unit is located within the area.

4. The method of claim 2, further comprising the step of terminating access to the network services in response to the mobile unit leaving the area.

5. The method of claim 4, wherein the terminating step terminates access to one or more of the internet, email, instant messaging, and a wireless local area network.

6. The method of claim 1, wherein the determining step comprises reading an RFID tag coupled to the mobile unit.

7. The method of claim 1, wherein the enabling step enables access to one or more of the internet, email, instant messaging, and a wireless local area network.

8. A system for controlling mobile unit access to network services based on a location of a mobile unit, comprising:
a reader configured to determine if the mobile unit is located within an area; and
a switch coupled to the reader, the switch configured to provide access to the network services, to the mobile unit, in response to the reader determining that the mobile unit is located within the area.

9. The system of claim 8, wherein the reader is further configured to monitor the location of the mobile unit to determine if the mobile unit remains located within the area.

10. The system of claim 9, wherein the switch is further configured to continue to enable the mobile unit to access the network services while the mobile unit is located within the area.

11. The system of claim 9, wherein the switch is further configured to terminate access to the network services in response to the reader determining that the mobile unit is no longer within the area.

12. The system of claim 11, wherein the network services comprise one or more of the internet, email, instant messaging, and a wireless local area network.

13. The system of claim 8, wherein the reader is further configured to read an RFID tag integrated with the mobile unit.

14. The system of claim 8, wherein the network services comprise one or more of the internet, email, instant messaging, and a wireless local area network.

15. An apparatus for controlling mobile unit access to network services based on a location of a mobile unit, comprising:
means for determining if the mobile unit is located within an area; and
means for enabling the mobile unit to access the network services in response to determining that the mobile unit is located within the area.

16. The apparatus of claim 15, further comprising means for monitoring the mobile unit to determine if the mobile unit remains located within the area.

17. The apparatus of claim 16, further comprising means for continuing to enable the mobile unit to access the network services while the mobile unit is located within the area.

18. The apparatus of claim 16, further comprising means for terminating access to the network services if the mobile unit leaves the area.

19. The apparatus of claim 18, further comprising:
means for determining that the mobile unit has returned to the area; and
means for re-enabling the mobile unit to access the network services in response to the mobile unit returning to the area.

20. The apparatus of claim 15, wherein the enabling means comprises means for enabling internet access, email access, instant messaging access, and access to a wireless local area network.
